(19) United States
(12) Patent Application Publication
(10) Pub. No.: US 2022/0154520 A1
(43) Pub. Date: May 19, 2022

(54) INVISIBLE SILL - THERMALLY BROKEN

(71) Applicant: GOLDBRECHT LLC, Culver City, CA (US)

(72) Inventor: Marcel FONTIJN, Culver City, CA (US)

(73) Assignee: GOLDBRECHT LLC, Culver City, CA (US)

(21) Appl. No.: 16/951,276

(22) Filed: Nov. 18, 2020

(51) Int. Cl. E06B 3/263; E06B 3/26

(52) U.S. Cl. CPC E06B 3/26305; E06B 3/42; E06B 2003/26312; E06B 3/26

(57) ABSTRACT

There is included an intermediate element including one or more, but not necessarily limited to, an L-shaped profiled portion configured to receive a part of a panel of a door or window, a pad configured to be fit into at least one frame part and comprising a support strip groove, and an intermediate element extended from the L-shaped portion to the pad.

### BACKGROUND

### 1. Field

The disclosed subject matter relates to framing for elements, such as sliding windows and doors having one or more panels.

### 2. Description of Related Art

Conventional methods and apparatuses for moving windows, doors, and other elements in a frame may include sliding and or positioning an element in and along a track. With various frames, such as a fixed frame, there may be difficulty in adequately positioning and arranging elements therein without impairing an aesthetic and without creating a tripping hazard from various protruded elements that may become misaligned due to complicated structures.

Exemplary embodiments offer solutions with respect to problems associated with the prior methods and apparatuses for positioning such elements.

### SUMMARY

According to exemplary embodiments, there is one or more of an intermediate element including an L-shaped profiled portion configured to receive a part of a panel of a door or window, a pad configured to be fit into at least one frame part and comprising one of a support strip groove, and an intermediate element extended from the L-shaped portion to the pad, and wherein the intermediate element is integral with the L-shaped profiled portion and the pad.

According to exemplary embodiments, the pad and at least a first part of the intermediate element are configured to fit within the at least one frame part holding a surface such as a floor, a ceiling or a cut-out of a wall for example, and the L-shaped profiled portion and at least a second part of the intermediate element are configured to protrude from the at least one frame part and the surface, and the L-shaped profiled portion comprises a seal groove, and the intermediate element is extended from the L-shaped portion to the pad in a direction in which the seal groove is configured to receive a seal, and the L-shaped profiled portion is configured to be separated from the surface, when the pad is fit into the at least one frame part and the seal is fit into the seal groove, by the seal fit into the seal groove.

According to exemplary embodiments, there is another L-shaped profiled portion configured to receive another part of the panel and comprising another seal groove, another pad configured to be fit into at least one other frame part, and another intermediate element extended from the other L-shaped profiled portion to the other pad in a direction in which the other seal groove is configured to receive another seal which matches the direction in which the seal groove is configured to receive the seal, wherein the L-shaped profiled portion is joined to the other L-shaped profiled portion, and wherein the pad is joined to the another pad.

According to exemplary embodiments, the intermediate element and the other intermediate element are configured to extend through a same opening between the at least one frame part and the at least one other frame part when the pad is fitted to the at least one frame part and the other pad is fitted to the at least one other frame part.

According to exemplary embodiments, the other pad and at least a first part of the other intermediate element are configured to fit within the at least one other frame part holding another surface such as a floor, a ceiling or a cut-out of a wall for example, and the other L-shaped profiled portion and at least a second part of the other intermediate element are configured to protrude from the at least one other frame part and the other surface.

According to exemplary embodiments, the other L-shaped profiled portion is configured to be separated from the other surface, when the other pad is fit into the at least one other frame part and the other seal is fit into the other seal groove, by the other seal fit into the other seal groove.

According to exemplary embodiments, there is a first connector extended from a groove of the L-shaped profiled portion to another groove of the other L-shaped profiled portion, and the L-shaped profiled portion is joined to the other L-shaped profiled portion by the first connector.

According to exemplary embodiments, there is a second connector, and the first connector is extended from the L-shaped profiled portion to the other L-shaped profiled portion, and the second connector is extended from a groove of the pad to another groove of the other pad, and the pad is joined to the other pad by the second connector, and the first connector and the second connector comprise a material different than a material of the L-shaped profiled portion, and the material of the L-shaped profiled portion comprises a metal, and wherein the L-shaped profiled portion, the intermediate element, and the pad are integrally formed and comprise a metal.

According to exemplary embodiments, the first connector substantially fills a space between the intermediate element and the other intermediate element from the L-shaped profiled portion to the pad.

According to exemplary embodiments, first connector is extended through a hole in the intermediate element and a hole in the other intermediate element.

According to exemplary embodiments, the L-shaped profiled part, the intermediate element, and the pad are configured such that at least a portion of the at least one frame part is visible when the pad is fit to the at least one frame part and the part of the panel is fit to the L-shaped profiled part.

According to exemplary embodiments, there is an L-shaped profiled portion configured to receive a part of a panel of a door or window, a pad configured to be fit into at least one frame part and comprising a support strip groove, and an intermediate element extended from the L-shaped portion to the pad, another L-shaped profiled portion configured to receive another part of the panel of the door or window, another pad configured to be fit into at least one other frame part, and another intermediate element extended from the other L-shaped profiled portion to the other pad, wherein the L-shaped profiled portion is joined to the other L-shaped profiled portion, and wherein the pad is joined to the another pad.

According to exemplary embodiments, there is a first connector extended from a groove of the L-shaped profiled portion to another groove of the other L-shaped profiled portion and a second connector extended from a groove of the pad to another groove of the other pad, wherein the L-shaped profiled portion is joined to the other L-shaped profiled portion by the first connector, and wherein the pad is joined to the other pad by the second connector.

According to exemplary embodiments, the first connector and the second connector comprise a material different than a material of the L-shaped profile portion, and the material of the L-shaped profile portion comprises metal.

According to exemplary embodiments, the first connector and the second connector each comprise a thermal resistance greater than the L-shaped profile portion.

According to exemplary embodiments, the first connector substantially fills a space between the intermediate element and the other intermediate element from the L-shaped profiled portion to the pad.

According to exemplary embodiments, the first connector is extended through a hole in the intermediate element and a hole in the other intermediate element.

According to exemplary embodiments, the L-shaped profile, the intermediate element, the pad are integrally formed and comprise metal, and the other L-shaped profile portion, the other intermediate element, and the other pad are integrally formed and comprise metal.

According to exemplary embodiments, the pad and at least a first part of the intermediate element are configured to fit within the at least one frame part holding a surface such as a floor, a ceiling, or a cut-out of a wall, and the L-shaped profiled portion and at least a second part of the intermediate element are configured to protrude from the at least one frame part and the surface.

According to exemplary embodiments, the other pad and at least a first part of the other intermediate element are configured to fit within the at least one other frame part holding another surface such as a floor, a ceiling or cut-out of a wall for example, and the other L-shaped profiled portion and at least a second part of the other intermediate element are configured to protrude from the at least one other frame part and the other surface.

According to exemplary embodiments, the intermediate element and the other intermediate element are configured to extend through a same opening between the at least one frame part and the at least one other frame part when the pad is fitted to the at least one frame part and the other pad is fitted to the at least one other frame part.

According to exemplary embodiments, the L-shaped profiled part, the intermediate element, the pad, the other L-shaped profiled part, the other intermediate element, and the other pad are configured such that at least a portion of the at least one frame part and at least a portion of the at least one other frame part are visible depending on a position of the intermediate element when the pad is fit to the at least one frame part, the part of the panel is fit to the L-shaped profiled part, the other pad is fit to the at least one other frame part, and the other part of the panel is fit to the other L-shaped profiled part.

### BRIEF DESCRIPTION OF THE DRAWINGS

Further features, nature, and various advantages of the disclosed subject matter will be more apparent from the following detailed description and the accompanying drawings in which:

FIG. 1A is a schematic illustration of elements in accordance with exemplary embodiments.

FIG. 1B is a schematic illustration of elements in accordance with exemplary embodiments.

FIG. 1C is a schematic illustration of elements in accordance with exemplary embodiments.

FIG. 2 is a schematic illustration of elements in accordance with exemplary embodiments.

FIG. 3 is a schematic illustration of elements in accordance with exemplary embodiments.

FIG. 4 is a schematic illustration of elements in accordance with exemplary embodiments.

FIG. 5 is a schematic illustration of elements in accordance with exemplary embodiments.

FIG. 6 is a schematic illustration of elements in accordance with exemplary embodiments.

FIG. 7 is a schematic illustration of elements in accordance with exemplary embodiments.

### DETAILED DESCRIPTION

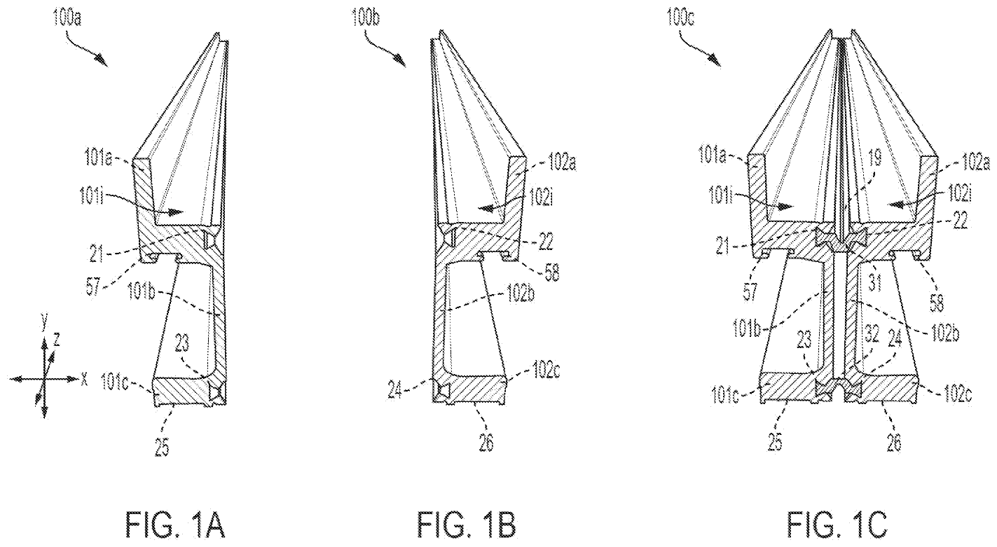

FIG. 1A is a schematic illustration of elements in accordance with exemplary embodiments.

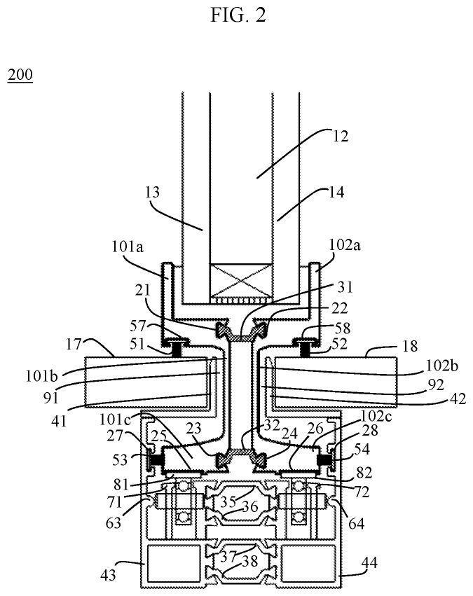

FIG. 1A illustrates a single piece element 100a, which may be referred to as an intermediate element, and which includes an L-shaped portion 101a, an intermediate portion 101b, and a pad 101c. The single piece element 100a is configured to be set into a frame, such as one or more of the frame parts 41, 42, 43, 44 and/or the surfaces 17 and 18 described further with respect to FIG. 2. The single piece element 100a may be made entirely of metal.

According to exemplary embodiments, the single piece element 100a includes various grooves, such as the grooves 21 and 23 and the grooves 57 and 25. As described with FIGS. 1C and 2, the grooves 21 and 23 may join the single piece element 100a to a single piece element 100b, of FIG. 1B, via one or more of the connectors 31 and 32. The grooves 57 and 25 will be described further with respect to FIG. 2.

As shown in FIG. 1A, the L-shaped portion 101a comprises inner surfaces 101i configured to receive one or more elements, such as a panel face 13, which a part of a panel, such as illustrated in FIG. 2. A bottom portion of the L-shaped portion 101a, in the y-direction, comprises grooves 57 which may attach to a seal 51 as in FIG. 2, where the seal 51 may be a brush or other seal according to exemplary embodiments. The L-shaped portion 101a also includes grooves 21, which as shown in FIGS. 1C and 2, may attach to the L-shaped portion 102a via a connector 31, which may be made of a non-conductive material. The grooves 21 and 57, and similarly the grooves 23 and 25, may extend longitudinally along the z-direction shown in FIG. 1A along the entire length of the single piece element 100a.

The L-shaped portion 101a in FIG. 1A is shown as attached to the pad 101c via an intermediate portion 101b, and the pad 101c may include one or more of the grooves 23 and 25. According to exemplary embodiments, the grooves 25 of the pad 101c may or may not attach to a support strip, such as a support strip 56 shown in FIG. 2. The pad 101c may also be attached to a seal, such as the seal 53 shown in FIG. 2, and the seal 53 may be a brush or other seal according to exemplary embodiments. The pad 101c also includes grooves 23, which as shown in FIGS. 1C and 2, may attach to the pad 102c via a connector 32, which may be made of a non-conductive material similar to the connector 31.

An end of the L-shaped portion 101a, away from the intermediate portion 101b in both the x and y-directions, is extended in the y-direction from one of the surfaces 101i of the L-shaped portion 101a where such one of the surfaces 101i of the L-shaped portion 101a is extended in the x-direction and joined to the intermediate portion 101b. The intermediate portion 101b is extended therefrom in the y-direction to the pad 101c which is extended away from the intermediate portion in the x and y-directions as shown in FIG. 1A. Further, the elements of the single piece element 100a, such as the L-shaped portion 101a, the intermediate portion 101b, the pad 101, and the grooves 21, 23, 25, and 57 may be extended in the z-direction, as shown in FIG. 1A.

FIG. 1B is a schematic illustration of elements in accordance with exemplary embodiments.

FIG. 1B illustrates a single piece element 100b, which may also be referred to as an intermediate element, and which includes an L-shaped portion 102a, an intermediate portion 102b, and a pad 102c. The single piece element 100b is configured to be set into a frame, such as one or more of the frame parts 41, 42, 43, 44 and/or the surfaces 17 and 18 described further with respect to FIG. 2. The single piece element 100b may be made entirely of metal.

According to exemplary embodiments, the single piece element 100b includes various grooves, such as the grooves 22 and 24 and the grooves 58 and 26. As described with FIGS. 1C and 2, the grooves 22 and 24 may join the single piece element 100b to a single piece element 100a, of FIG. 1A, via one or more of the connectors 31 and 32. The grooves 58 and 26 will be described further with respect to FIG. 2.

As shown in FIG. 1B, the L-shaped portion 102a comprises inner surfaces 102i configured to receive one or more elements, such as a panel face 14, which is another part of a panel, such as illustrated in FIG. 2. The panel faces 13 and 14 may each be parts of a single insulated glass unit (panel) that is comprises of two pieces of glass with a spacer 12 glued between them. A bottom portion of the L-shaped portion 102b, in the y-direction, comprises grooves 58 which may attach to a seal 52 as in FIG. 2, and the seal 52 may be a brush or other seal according to exemplary embodiments. The L-shaped portion 102a also includes grooves 22, which as shown in FIGS. 1C and 2, may attach to the L-shaped portion 102a via a connector 31, which may be made of a non-conductive material.

The L-shaped portion 102a in FIG. 1B is shown as attached to the pad 102c via an intermediate portion 102b, and the pad 102c may include one or more of the grooves 24 and 26. According to exemplary embodiments, the grooves 26 of the pad 102c may or may not attach to a support strip, such as a support strip 56, as shown in FIG. 2. The pad 102c may also be attached to a seal, such as the seal 54 shown in FIG. 2, and the seal 54 may be a brush or other seal according to exemplary embodiments. The pad 102c also includes grooves 24, which as shown in FIGS. 1C and 2, may attach to the pad 101c via a connector 32, which may be made of a non-conductive material similar to the connector 31. The grooves 22 and 58, and similarly the grooves 24 and 26, may extend longitudinally along the Z-direction shown in FIG. 1A along the entire length of the single piece element 100b.

An end of the L-shaped portion 102a, away from the intermediate portion 102b in both the x and y-directions, is extended in the y-direction from one of the surfaces 102i of the L-shaped portion 102a where such one of the surfaces 102i of the L-shaped portion 102a is extended in the x-direction and joined to the intermediate portion 102b. The intermediate portion 102b is extended therefrom in the y-direction to the pad 102c which is extended away from the intermediate portion in the x and y-directions as shown in FIG. 1B. Further, the elements of the single piece element 100b, such as the L-shaped portion 102a, the intermediate portion 102b, the pad 102, and the grooves 22, 24, 26, and 58 may be extended in the z-direction, as shown in FIG. 1B.

FIG. 1C is a schematic illustration of elements in accordance with exemplary embodiments.

FIG. 1C illustrates an element 100c, which may also be referred to as an intermediate element, and which, according to exemplary embodiments, includes the single piece element 100a joined to the single piece element 100b of FIGS. 1A and 1B via the connectors 31 and 32 which may be made of a non-conductive material. The L-shaped portions 101a and 102a, the intermediate elements 101b and 102b, the pads 101c and 102c, the grooves 21 and 22, the grooves 57 and 58, the grooves 23 and 24, and the grooves 25 and 26 may be mirrored and bilaterally symmetric as illustrated in FIG. 1C. Further, the extension 19 of the connector 31 is shown in FIG. 1C as extended between the single piece elements 100a and 100b in the z-direction, and the connector 32 may similarly be extended.

As in FIG. 1C, and similarly as in FIG. 2, the L-shaped portions 101a and 102a each symmetrically extend away from an x-direction center of the element 100c through which the connectors 31 and 32 are shown extended between the areas having the L-shaped portions 101a and 102a, the intermediate elements 101b and 102b, and the pads 101c and 102c. According to exemplary embodiments, an area between the intermediate elements 101b and 102b in the x-direction may be hollow.

The L-shaped portion 101a, the intermediate element 101b, and the pad 101c may be made of a same metal and may be integrally formed, and the other L-shaped portion 102a, the other intermediate element 102b, and the other pad 102c may be made of the same metal and maybe integrally formed. The connectors 31 and 32 may be made of different materials than the metal of the single piece element 100a and the single piece element 110b and may have a greater thermal resistivity than any of the portions of the single piece element 100a and the single piece element 110b. Further, the single piece element 100a, the single piece element 110b, and the element 100c when fitted into the frame parts as shown and described with respect to FIG. 2, are configured such that at least part of the frame parts remain visible from the surface such as a floor, a ceiling or cut-out of a wall for example.

FIG. 2 is a schematic illustration of elements in accordance with exemplary embodiments.

FIG. 2 illustrates connections 200 representing exemplary embodiments, which may involve an invisible sill, in which the element 100c, such as shown in FIG. 1C, is attached to various elements, such as the panel faces 13 and 14 of a panel which may be a sliding window, the seals 51 and 52, the seals 53 and 54 and support strips 81 and 82. Although the elements shown in FIG. 2 are illustrated in cross-section of the above-noted x and y-directions, the elements extend in the above-noted z-direction as well according to embodiments.

The inner surfaces of the L-shaped portions 101a and 102a are illustrated in FIG. 2 as holding panel faces 13 and 14 of the panel therebetween. The L-shaped portions 101a and 102a are also shown as raised above the surfaces 17 and 18 and the frame parts 41, 42, 43, and 44 such that at least portions of the surfaces 17 and 18 and the frame parts 41 and 42 may or may not be partly visible but are not obscured by the element 100c described with respect to FIG. 1C. The frame parts 41, 42, 43, and 44 represent portions of a fixed frame. The surfaces 17 and 18 may be any of a floor, a ceiling, or a cut-out of a wall, and portions of a raised or indented platform for example. The L-shaped portions 101a and 102a may be raised from the surfaces 17 and 18 by respective ones of the seals 51 and 52 which connect to lower portions of the L-shaped portions 101a and 102a and the support strips 57 and 58 along tracks respectively.

As shown in FIG. 2, the intermediate elements 101b and 102b are at least partly extended from above the surfaces 17 and 18 from the L-shaped portions 101a and 102a through openings 91 and 92, which form a same passage between the frame parts 41 and 42 through to below, in the y-direction, the surfaces 17 and 18 to the pads 101c and 102c. The frame parts 41 and 42 may comprise extensions holding the surfaces 17 and 18 therebetween as shown in FIG. 2, and the frame parts 41 and 42 similarly may be attached to the frame parts 43 and 44 by one or more of flexible projections which may connect to ones of projection ribs if any.

FIG. 2 illustrates that outer portions of the pads 101c and 102c are connected to seals 53 and 54 which are connected into grooves 27 and 28 of inner surfaces of the frame parts 43 and 44. Further, the bottom portions of the pads 101c and 102c may be seated on the intermediate element portions 71 and 72 by at least one support strips 57 and 58, and the intermediate element portions 71 and 72 may include actuation elements, such as rolling features, held in place by at least one or more ribs 63 and 64 shown in FIG. 2 as part of an inner surface of the frame parts 43 and 44.

Lower portions of the frame parts 43 and 44 and also portions of the intermediate element portions 71 and 72 may be connected by means of connectors, such as elements 35, 36, 37, and 38 which may be alternate arrangements of elements such as the connects 31 and 32 described herein. Any of the connectors 35, 36, 37, and 38 and connectors 31 and 32 may be made of a non-conductive material and thereby may act as thermal breaks between one or more portions to which those connectors may be connected so as to resist thermal energy transfer between those portions while maintaining connection there between.

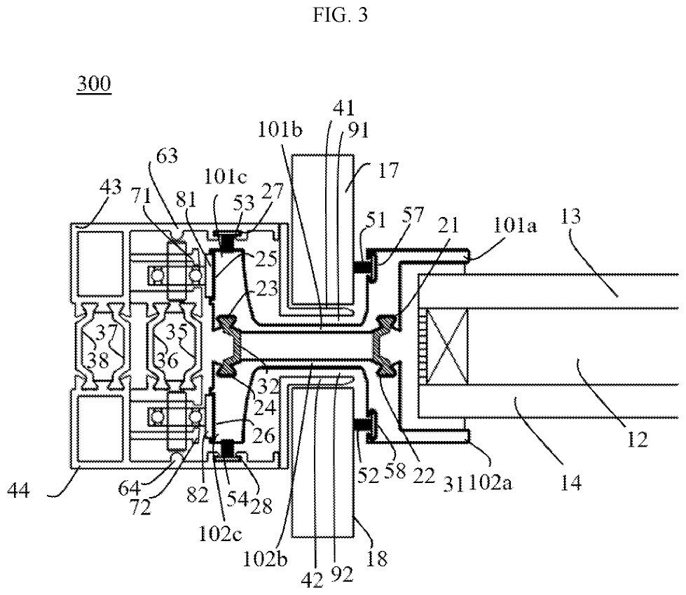

FIG. 3 is a schematic illustration of elements in accordance with exemplary embodiments.

FIG. 3 illustrates connections 300 representing one or more exemplary embodiments including those elements shown and described with respect to FIG. 2 but also turned horizontally so as to run up a wall such as for a guillotine window, and may involve an invisible sill, in which the element 100c, such as shown in FIG. 1C, is attached to various elements, such as the panel faces 13 and 14 of a panel which may be a sliding window, the seals 51 and 52, the seals 53 and 54 and support strips 57 and 58 along tracks. Although the elements shown in FIG. 3 are illustrated in cross-section of the above-noted x and y-directions, the elements extend in the above-noted z-direction as well according to embodiments.

The inner surfaces of the L-shaped portions 101a and 102a are illustrated in FIG. 3 as holding panel faces 13 and 14 of the panel therebetween. The L-shaped portions 101a and 102a are also shown as extended beyond the surfaces 17 and 18 and the frame parts 41, 42, 43, and 44 such that at least portions of the surfaces 17 and 18 and the frame parts 41 and 42 may or may not be visible but are not obscured by the element 100c described with respect to FIG. 1C. According to exemplary embodiments, frame parts 41 and 42 may or may not be visible depending on whether other ones of the illustrated portions are slid into closed or open positions. For example, frame parts 41 and 42 may be visible in an open position and not visible in a closed position, and the surfaces 17 and 18 may be visible in both open and closed positions. The open and closed positions may depend on whether a window, described further below, is slid open or closed. The frame parts 41, 42, 43, and 44 represent portions of a fixed frame. The surfaces 17 and 18 may be any of a floor, a ceiling, a cut-out of a wall, and portions of a raised or indented platform for example. The L-shaped portions 101a and 102a may be extended from the surfaces 17 and 18 by respective ones of the seals 51 and 52 which connect to portions of the L-shaped portions 101a and 102a at the grooves 57 and 58 respectively.

As shown in FIG. 3, the intermediate elements 101b and 102b are at least extended from above the surfaces 17 and 18 from the L-shaped portions 101a and 102a through openings 91 and 92, which form a same passage between the frame parts 41 and 42 through to below, in the y-direction, the surfaces 17 and 18 to the pads 101c and 102c. The frame parts 41 and 42 may comprise extensions holding the surfaces 17 and 18 therebetween as shown in FIG. 3, and the frame parts 41 and 42 similarly may be attached to the frame parts 43 and 44 by one or more of flexible projections which may connect to ones of projection ribs, if any.

FIG. 3 illustrates that outer portions of the pads 101c and 102c are connected to seals 53 and 54 which are connected into grooves 27 and 28 of inner surfaces of the frame parts 43 and 44. Further, the bottom portions of the pads 101c and 102c may be seated on the intermediate element portions 71 and 72 by at least one support strip 81 and 82, and the intermediate element portions 71 and 72 may include actuation elements, such as rolling features, held in place by at least one or more ribs 63 and 64 shown in FIG. 2 as part of an inner surface of the frame parts 43 and 44.

Lower portions of the frame parts 43 and 44 and also portions of the intermediate element portions 71 and 72 may be connected by means of connectors, such as elements 35, 36, 37, and 38 which may be alternate arrangements of elements such as the connects 31 and 32 described herein. Any of the connectors 35, 36, 37, and 38 and connectors 31 and 32 may be made of a non-conductive material and thereby may act as thermal breaks between one or more portions to which those connectors may be connected so as to resist thermal energy transfer between those portions while maintaining connection there between.

The terminology used between elements in FIGS. 2 and 3 are used similarly for consistency; however, as noted above, it will be understood that FIG. 3 represents various embodiments in which those elements of FIG. 2 may be turned horizontally so as to, for example, run up a wall such as in a guillotine window.

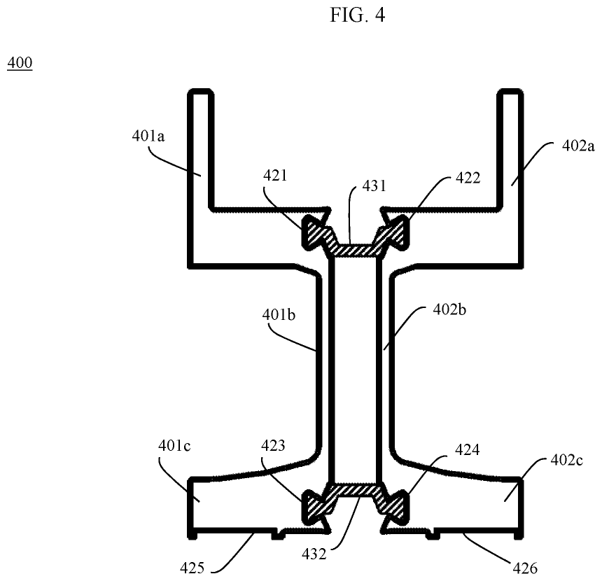

Exemplary embodiments of modification will be described with respect to FIGS. 4, 5, 6, and 7 and are interchangeable with embodiments described above with respect to FIGS. 1A, 1B, 1C, 2, and 3 for advantageous effects depending on various situations as would be understood by one of ordinary skill in the art from view of the present disclosure.

FIG. 4 is a schematic illustration of elements in accordance with exemplary embodiments. As compared with one or more other embodiments, embodiments of FIG. 4 may not have a seal included at the L-shaped portions 401a and 402a.

FIG. 4 illustrates an element 400, which may also be referred to as an intermediate element, and which, according to exemplary embodiments, includes a single piece element joined to another single piece element, like with the single piece element 100a joined to the single piece element 100b of FIGS. 1A and 1B, via the connectors 431 and 432 which may be made of a non-conductive material. The single piece elements include L-shaped portions 401a and 402a, the intermediate elements 401b and 402b, the pads 401c and 102c, the grooves 421 and 422, the grooves 423 and 424, and the grooves 425 and 426 may be mirrored and bilaterally symmetric as illustrated in FIG. 4. Further, the extension 19 of the connector 31 is shown in FIG. 1C as extended between the single piece elements 100a and 100b in the z-direction, and such connector 32 may similarly be extended with respect to the elements shown in FIG. 4 according to embodiments.

As in FIG. 4, and similarly as in FIG. 2, the L-shaped portions 401a and 402a each symmetrically extend away from an x-direction center through which the connectors 431 and 432 are shown extended between the areas having the L-shaped portions 401a and 402a, the intermediate elements 401b and 402b, and the pads 401c and 402c. According to exemplary embodiments, an area between the intermediate elements 401b and 402b in the x-direction may be hollow.

The L-shaped portion 401a, the intermediate element 401b, and the pad 401c may be made of a same metal and may be integrally formed, and the other L-shaped portion 402a, the other intermediate element 402b, and the other pad 402c may be made of the same metal and maybe integrally formed. The connectors 431 and 432 may be made of different materials than the metal of the single piece elements and may have a greater thermal resistivity than any of the portions of the single piece elements. Further, the single piece elements when fitted into the frame parts as shown and described with respect to FIG. 2, are configured such that at least part of the frame parts remain visible from the surface, such as the floor, the ceiling or the cut-out of to wall for example, according to exemplary embodiments including those of FIG. 4.

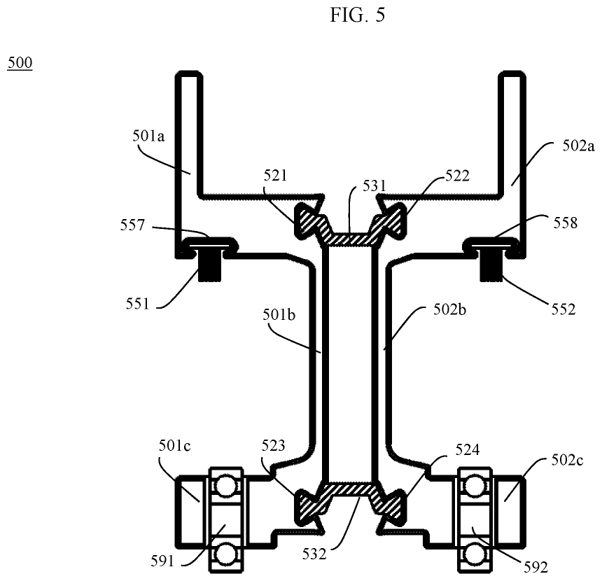

FIG. 5 is a schematic illustration of elements in accordance with exemplary embodiments. As compared with other embodiments, embodiments of FIG. 5 may include roller bearings 591 and 592 mounted on the pads 501c and 502c instead of necessarily using one or more of the tracks described above.

FIG. 5 illustrates an element 500, which may also be referred to as an intermediate element, and which, according to exemplary embodiments, includes a single piece element joined to another single piece element, like with the single piece element 100a joined to the single piece element 100b of FIGS. 1A and 1B, via the connectors 531 and 532 which may be made of a non-conductive material. The single piece elements include L-shaped portions 501a and 502a, the intermediate elements 501b and 502b, the pads 501c and 502c, the grooves 557 and 558 with illustrated seals 551 and 552, and the grooves 523 and 524, may be mirrored and bilaterally symmetric as illustrated in FIG. 5, and the seals 551 and 552 may be brushes or other seals according to exemplary embodiments. Further, the extension 19 of the connector 31 is shown in FIG. 1C as extended between the single piece elements 100a and 100b in the z-direction, and the connector 32 may similarly be extended with respect to the elements shown in FIG. 5 according to embodiments.

As in FIG. 5, and similarly as in FIG. 2, the L-shaped portions 501a and 502a each symmetrically extend away from an x-direction center through which the connectors 531 and 532 are shown extended between the areas having the L-shaped portions 501a and 502a, the intermediate elements 501b and 502b, and the pads 501c and 502c. According to exemplary embodiments, an area between the intermediate elements 501b and 502b in the x-direction may be hollow.

The L-shaped portion 501a, the intermediate element 501b, and the pad 501c may be made of a same metal and may be integrally formed, and the other L-shaped portion 502a, the other intermediate element 502b, and the other pad 502c may be made of the same metal and maybe integrally formed. The connectors 531 and 532 may be made of different materials than the metal of the single piece elements and may have a greater thermal resistivity than any of the portions of the single piece elements. Further, the single piece elements when fitted into the frame parts as shown and described with respect to FIG. 2, are configured such that at least part of the frame parts remain visible from the surface, such as the floor, the ceiling or the cut-out of the wall for example, according to exemplary embodiments including those of FIG. 5.

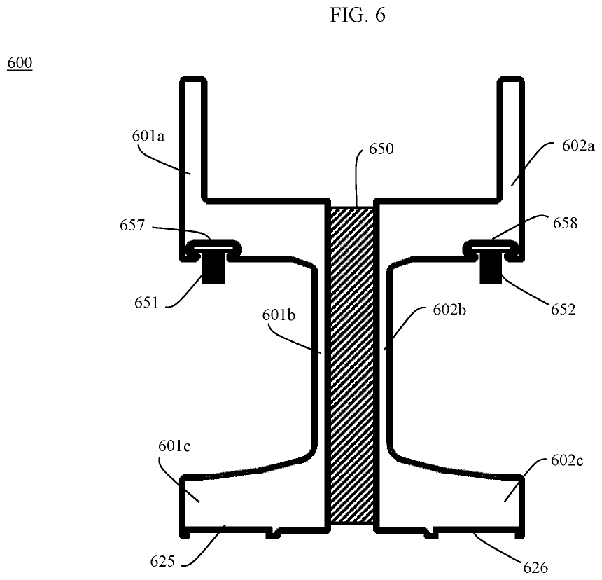

FIG. 6 is a schematic illustration of elements in accordance with exemplary embodiments. As compared with other embodiments, embodiments of FIG. 6 may include a thermal connector 650 as a pour-in or bonded version described further below.

FIG. 6 illustrates an element 600, which may also be referred to as an intermediate element, and which, according to exemplary embodiments, includes a single piece element joined to another single piece element, like with the single piece element 100a joined to the single piece element 100b of FIGS. 1A and 1B, via a thermal connector 650 which may be a pour-in or bonded version adhering the intermediate elements shown in FIG. 6 and may be made of a non-conductive material. The single piece elements include L-shaped portions 601a and 602a, the intermediate elements 601b and 602b, the pads 601c and 602c, the grooves 657 and 658 with illustrated seals 651 and 652 (or without those seals where the seals 651 and 652 may be brushes or other seals according to exemplary embodiments), and the grooves 625 and 626 may be mirrored and bilaterally symmetric as illustrated in FIG. 6. Further, the extension 19 of the connector 31 is shown in FIG. 1C as extended between the single piece elements 100a and 100b in the z-direction, and the connector 650 may similarly be extended with respect to the elements shown in FIG. 6 according to embodiments.

As in FIG. 6, and similarly as in FIG. 2, the L-shaped portions 601a and 602a each symmetrically extend away from an x-direction center through which the connector 650 is shown extended between the areas having the L-shaped portions 601a and 602a, the intermediate elements 601b and 602b, and the pads 601c and 602c. According to exemplary embodiments, an area between the intermediate elements 601b and 602b in the x-direction may be partly hollow or substantially filled with the connector 650.

The L-shaped portion 601a, the intermediate element 601b, and the pad 601c may be made of a same metal and may be integrally formed, and the other L-shaped portion 602a, the other intermediate element 602b, and the other pad 602c may be made of the same metal and maybe integrally formed. The connector 650 may be made of one or more of different materials than the metal of the single piece elements and may have a greater thermal resistivity than any of the portions of the single piece elements. Further, the single piece elements when fitted into the frame parts as shown and described with respect to FIG. 2, are configured such that at least part of the frame parts remain visible from the surface, such as the floor, the ceiling or the cut-out of the wall for example, according to exemplary embodiments including those of FIG. 6.

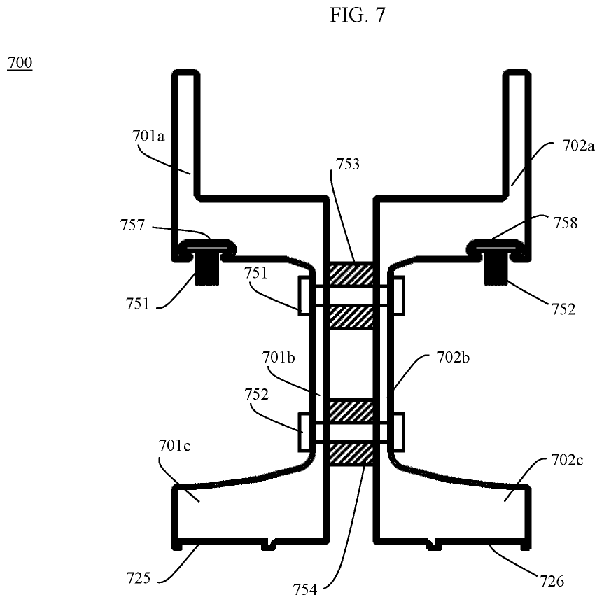

FIG. 7 is a schematic illustration of elements in accordance with exemplary embodiments. As compared with other embodiments, embodiments of FIG. 7 may include thermal connectors 751, 753 and 752, 754 as fasteners and spacers described further below.

FIG. 7 illustrates an element 700, which may also be referred to as an intermediate element, and which, according to exemplary embodiments, includes a single piece element joined to another single piece element, like with the single piece element 100a joined to the single piece element 100b of FIGS. 1A and 1B, via the connectors 751, 753 and 752, 754 which may be made of a non-conductive material as a fastener and spacer version in contrast to other exemplary embodiments. The single piece elements include L-shaped portions 701a and 702a, the intermediate elements 701b and 702b, the pads 701c and 702c, openings through which the connectors 751 and 752 pass through the intermediate elements 701b and 702b, the grooves 757 and 758 with illustrated seals 751 and 752 (or without those seals where the seals may be brushes or other seals according to exemplary embodiments), and the grooves 725 and 726 may be mirrored and bilaterally symmetric may be mirrored and bilaterally symmetric as illustrated in FIG. 7. Further, the extension 19 of the connector 31 is shown in FIG. 1C as extended between the single piece elements 100a and 100b in the z-direction, and the plurality of connectors 751, 753 and 752, 754, such as in sequence along the z-direction, may similarly be extended with respect to the elements shown in FIG. 7 according to exemplary embodiments.

As in FIG. 7, and similarly as in FIG. 2, the L-shaped portions 701a and 702a each symmetrically extend away from an x-direction center through which the connectors 751,752, 753, and 754 are shown extended between the areas having the L-shaped portions 701a and 702a, the intermediate elements 701b and 702b, and the pads 701c and 702c. According to exemplary embodiments, an area between the intermediate elements 701b and 702b in the x-direction may be hollow.

The L-shaped portion 701a, the intermediate element 701b, and the pad 701c may be made of a same metal and may be integrally formed, and the other L-shaped portion 702a, the other intermediate element 702b, and the other pad 702c may be made of the same metal and maybe integrally formed. The plurality of connectors 751, 753 and 752, 754 between may be made of different materials than the metal of the single piece elements and may have a greater thermal resistivity than any of the portions of the single piece elements. Further, the single piece elements when fitted into the frame parts as shown and described with respect to FIG. 2, are configured such that at least part of the frame parts remain visible from the surface, such as the floor, the ceiling or the cut-out of the wall for example, according to exemplary embodiments including those of FIG. 7.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

1. An intermediate element comprising:
an L-shaped portion configured to receive a part of a panel of a door or window;
a pad configured to be fit into at least one frame part; and
an intermediate portion extended from the L-shaped portion to the pad,
wherein the intermediate portion is integral with the L-shaped portion and the pad,
wherein each of the L-shaped portion and the pad extend away from the intermediate portion in a first direction, and
wherein at least one of the L-shaped portion and the pad comprise a face configured to receive a connector and facing in a second direction opposite to the first direction.

2. The intermediate element according to claim 1,
wherein the pad and at least a first part of the intermediate portion are configured to fit within the at least one frame part, and
wherein the L-shaped portion and at least a second part of the intermediate portion are configured to protrude from the at least one frame part,
wherein the L-shaped portion comprises a at least one groove, and
wherein the intermediate portion is extended from the L-shaped portion to the pad in a third direction that is substantially perpendicular to the second direction in which the at least one groove of the L-shaped portion is configured to receive the connector.

3. The intermediate element according to claim 2, further comprising:
another L-shaped portion configured to receive another part of the panel and comprising at least one other groove;
another pad configured to be fit into at least one other frame part; and
another intermediate portion extended from the other L-shaped portion to the other pad in the third direction,
wherein the L-shaped portion is joined to the other L-shaped portion, and
wherein the pad is joined to the other pad.

4. The intermediate element according to claim 3, wherein the intermediate portion and the other intermediate portion are configured to extend through a same opening between the at least one frame part and the at least one other frame part when the pad is fitted to the at least one frame part and the other pad is fitted to the at least one other frame part.

5. The intermediate element according to claim 3,
wherein the other pad and at least a first part of the other intermediate portion are configured to fit within the at least one other frame part, and
wherein the other L-shaped portion and at least a second part of the other intermediate portion are configured to protrude from the at least one other frame.

6. The intermediate element according to claim 5,
wherein the other intermediate portion is integral with the other L-shaped portion and the other pad.

7. The intermediate element according to claim 6, further comprising:
the connector;
wherein the connector is extended from the L-shaped portion to the other L-shaped portion, and
wherein the L-shaped portion is joined to the other L-shaped portion by the connector.

8. The intermediate element according to claim 7, further comprising:
a second connector;
wherein the connector is extended from the at least one groove of the L-shaped portion to the at least one other groove of the other L-shaped portion,
wherein the second connector is extended from a groove of the pad to another groove of the other pad,
wherein the pad is joined to the other pad by the second connector, and
wherein the first connector and the second connector comprise a material different than a material of the L-shaped portion.

9. The intermediate element according to claim 7, wherein the intermediate portion and the other intermediate portion are spaced apart from each other.

10. (canceled)

11. The intermediate element according to claim 2, wherein the L-shaped portion, the intermediate portion, and the pad are configured such that at least a portion of the at least one frame part is visible when the pad is fit to the at least one frame part and the part of the panel is fit to the L-shaped portion.

12. An intermediate element comprising:
an L-shaped portion configured to receive a part of a panel of a door or window;
a pad configured to be fit into at least one frame part;
an intermediate portion extended from the L-shaped portion to the pad;
another L-shaped portion configured to receive another part of the panel of the door or window;
another pad configured to be fit into at least one other frame part; and
another intermediate portion extended from the other L-shaped portion to the other pad,
wherein the L-shaped portion is joined to the other L-shaped portion, and
wherein the pad is joined to the another pad,
wherein each of the L-shaped portion and the pad extend away from the intermediate portion in a first direction, and
wherein at least one of the L-shaped portion and the pad comprise a face configured to receive a connector and facing in a second direction opposite to the first direction.

13. The intermediate element according to claim 12, further comprising:
the connector extended from the L-shaped portion to the other L-shaped portion,
wherein the L-shaped portion is joined to the other L-shaped portion by the connector.

14. The intermediate element according to claim 13, further comprising:
a second connector,
wherein the connector is extended from a groove of the L-shaped portion to another groove of the other L-shaped portion,
wherein the second connector is extended from a groove of the pad to another groove of the other pad,
wherein the pad is joined to the other pad by the second connector,
wherein the first connector and the second connector comprise a material different than a material of the L-shaped portion,
wherein the first connector and the second connector each comprise a thermal resistance greater than that of the L-shaped portion.

15. The intermediate element according to claim 13, wherein the intermediate portion and the other intermediate portion are spaced apart from each other.

16. The intermediate element according to claim 14, wherein the first connector is extended from the L-shaped portion to the other L-shaped portion in the second direction which is substantially perpendicular to a third direction in which the intermediate portion is extended from the L-shaped portion to the pad.

17. The intermediate element according to claim 12,
wherein the pad and at least a first part of the intermediate portion are configured to fit within the at least one frame part, and
wherein the L-shaped portion and at least a second part of the intermediate portion are configured to protrude from the at least one frame part.

18. The intermediate element according to claim 17,
wherein the other pad and at least a first part of the other intermediate portion are configured to fit within the at least one other frame part, and
wherein the other L-shaped portion and at least a second part of the other intermediate portion are configured to protrude from the at least one other frame part.

19. The intermediate element according to claim 12, wherein the intermediate portion and the other intermediate portion are configured to extend through a same opening between the at least one frame part and the at least one other frame part when the pad is fitted to the at least one frame part and the other pad is fitted to the at least one other frame part.

20. The intermediate element according to claim 12, wherein the L-shaped portion, the intermediate portion, the pad, the other L-shaped portion, the other intermediate portion, and the other pad are configured such that at least a portion of the at least one frame part and at least a portion of the at least one other frame part are visible depending on a position of the intermediate portion when the pad is fit to the at least one frame part, the part of the panel is fit to the L-shaped portion, the other pad is fit to the at least one other frame part, and the other part of the panel is fit to the other L-shaped portion
